(19) United States
(12) Patent Application Publication
(10) Pub. No.: US 2017/0127472 A1
(43) Pub. Date: May 4, 2017

(54) METHOD AND WIRELESS DEVICE FOR CONTROLLING DISCONNECTION OF A WIRELESS DEVICE IN A WI-FI DIRECT GROUP OF A WIRELESS NETWORK

(71) Applicant: ZTE Corporation, Shanzhan, Guangdong (CN)

(72) Inventor: Pengren Wang, Shenzhen (CN)

(21) Appl. No.: 15/106,905

(22) PCT Filed: May 7, 2014
(86) PCT No.: PCT/CN2014/076986

§ 371 Date: Jun. 21, 2016

(30) Foreign Application Priority Data
Dec. 23, 2013 (CN) 201310719354.7

(51) Int. Cl. H04W 76/06

(52) U.S. Cl. CPC H04W 76/064; H04W 84/12

(57) ABSTRACT

The embodiments of the present invention disclose a method and wireless device for controlling disconnection of a wireless device in a Wi-Fi Direct group of a wireless network, the method comprising: a wireless device; when other wireless devices connected thereto meet preset disconnection conditions, constructing a disconnection data frame corresponding to each one of the other wireless devices meeting preset disconnection conditions; the wireless device sending the constructed data frames to the corresponding other wireless devices, so that the other wireless devices receiving the data frames disconnect, according to the received data frames, from the wireless device; accordingly, the wireless device comprising: a data generation module and a data transmission module.

### TECHNICAL FIELD

The disclosure relates to the field of Wi-Fi Direct, and in particular to a method for controlling disconnection of a wireless device of a Wi-Fi Direct group, and a wireless device.

### BACKGROUND

In October, 2010, the Wi-Fi Alliance published a Wi-Fi Direct white paper, which introduced basic information, characteristics and functions regarding such a Wi-Fi Direct technology and clearly defined that the Wi-Fi Direct technology is characterized by allowing devices in a wireless network to be interconnected without using a wireless router. Since a Wi-Fi router or an Access Point (AP) is not necessary, different Wi-Fi devices may be interconnected at any places. A Wi-Fi Direct Device Discovery function and a Service Discovery function assist a user in determining available devices and services and then establishing a connection. Meanwhile, the Wi-Fi devices adopt Wi-Fi Protected Setup™, thereby simplifying a process of creating a secure inter-device connection.

In a novel network under a Wi-Fi Direct mode, a Wi-Fi Direct group, composed of two new roles namely a Group Owner (GO) and a Group Client (GC), emerges so as to support a Peer to Peer (P2P) connection. In a standard definition, a GO is compatible with a traditional Wi-Fi network, may serve as a Station (STA) or an AP (a wireless AP or a wireless router), and may, furthermore, also establish a P2P secure connection with a plurality of GCs, and a GC is similar to an STA, has functions of the STA, and can establish a P2P connection with a GO.

Currently, in a network structure adopting the Wi-Fi Direct technology, after networking is completed, a GO will serve as a gateway, and other nodes in the network are GCs.

However, in an existing Wifi Direct grouping environment, a GO only disconnects all GCs connected to the GO at a time, and cannot selectively disconnect GCs in the network, thereby making it unable to effectively and reasonably manage GCs in running environment of a Wifi Direct.

The above content is only intended to assist in understanding the technical solutions of the disclosure, and it is not indicated to admit that the above content is the prior art.

### SUMMARY

The embodiments of the disclosure are mainly intended to provide a method for controlling disconnection of a wireless device of a Wi-Fi Direct group, and a wireless device, which achieve selective disconnection of a wireless device of a Wi-Fi Direct group to further effectively and reasonably manage the wireless device of the Wi-Fi Direct group.

To this end, according to an embodiment of the disclosure, a method for controlling disconnection of a wireless device of a Wi-Fi Direct group is proposed, which may include that:

a wireless device constructs, when other wireless devices connected to the wireless device satisfy pre-set disconnection conditions, a data frame for disconnection corresponding to each of the other wireless devices satisfying the pre-set disconnection conditions; and

the wireless device transmits the constructed data frames to the respective other wireless devices such that the other wireless devices receiving the data frames are disconnected from the wireless device according to the received data frames.

Preferably, the wireless device may pre-store an information link list of the respective other wireless devices connected to the wireless device, and the method may further include that: after the wireless device transmits the constructed data frames to the respective other wireless devices such that the other wireless devices receiving the data frames are disconnected from the wireless device according to the received data frames,

when other wireless devices are disconnected from the wireless device, the wireless device looks up connection parameter information about the disconnected wireless devices from the pre-stored information link list of the respective other wireless devices connected to the wireless device, and deletes the connection parameter information.

Preferably, the step that the other wireless devices receiving the data frames are disconnected from the wireless device according to the received data frames may include that:

it is analyzed whether the data frames are data frames indicative of disconnection from the wireless device;

when the data frames are the data frames indicative of disconnection from the wireless device, reasons for and type of disconnection from the wireless device are acquired from the data frames, and it is analyzed whether the data frames are data frames indicative of immediate disconnection from the wireless device; and

when the data frames are the data frames indicative of immediate disconnection from the wireless device, the other wireless devices are disconnected from the wireless device, and the reasons for disconnection are prompted.

Preferably, after the step that the other wireless devices receiving the data frames analyze whether the data frames are the data frames indicative of immediate disconnection from the wireless device, the method may include that:

when the data frames are not the data frames indicative of immediate disconnection from the wireless device, timing is started; and

when a pre-set time period elapses, the other wireless devices are disconnected from the wireless device, and the reasons for disconnection are prompted.

Preferably, the step that the other wireless devices receiving the data frames start timing when the data frames are not the data frames indicative of immediate disconnection from the wireless device may include that:

when the data frames are not the data frames indicative of immediate disconnection from the wireless device, a reminding message indicative of disconnection from the wireless device after the pre-set time period is transmitted, and timing is started.

According to an embodiment of the disclosure, a wireless device applicable to the method for controlling disconnection of a wireless device of a Wi-Fi Direct group is further proposed, which may include:

a data generation module configured to construct, when other wireless devices connected to the wireless device satisfy pre-set disconnection conditions, a data frame for disconnection corresponding to each of the other wireless devices satisfying the pre-set disconnection conditions; and

a data transmitting module configured to transmit the constructed data frames to the respective other wireless devices such that the other wireless devices receiving the data frames are disconnected from the wireless device according to the received data frames.

Preferably, the wireless device may pre-store an information link list of the respective other wireless devices connected to the wireless device, and the wireless device may further include:

a processing module configured to look up, when other wireless devices are disconnected from the wireless device, connection parameter information about the disconnected wireless devices from the pre-stored information link list of the respective other wireless devices connected to the wireless device, and delete the connection parameter information.

Preferably, the wireless device may further include an analysis module and a disconnection response module, wherein

the analysis module is configured to analyze, when the wireless device is connected to the other wireless devices and receives the data frame for disconnections transmitted from the other wireless devices, whether the data frames are data frames indicative of disconnection from the wireless device;

the processing module is further configured to acquire, when the data frames are the data frames indicative of disconnection from the wireless device, reasons for and type of disconnection from the wireless device from the data frames, and the analysis module analyzes whether the data frames are data frames indicative of immediate disconnection from the wireless device; and

the disconnection response module is configured to disconnect, when the data frames are the data frames indicative of immediate disconnection from the wireless device, from the wireless device, and prompt the reasons for disconnection.

Preferably, the wireless device may further include a timing module, wherein

the timing module is configured to start timing when the data frames are not the data frames indicative of immediate disconnection from the wireless device; and

the disconnection response module is configured to disconnect, when a pre-set time period elapses, from the wireless device and prompt the reasons for disconnection.

Preferably, the processing module may be further configured to transmit, when the data frames are not the data frames indicative of immediate disconnection from the wireless device, a reminding message indicative of disconnection from the wireless device after the pre-set time period and the timing module starts timing.

According to an embodiment of the disclosure, a computer storage medium is further proposed. Computer executable instructions may be stored the computer storage medium and may be configured to execute the above method.

Compared with the prior art, the wireless device according to the embodiments of the disclosure constructs, when other wireless devices connected to the wireless device satisfy pre-set disconnection conditions, a data frame for disconnection corresponding to each of the other wireless devices satisfying the pre-set disconnection conditions; and the wireless device transmits the constructed data frames to the respective other wireless devices such that the other wireless devices receiving the data frames are disconnected from the wireless device according to the received data frames, thereby achieving selective disconnection of a wireless device of a Wi-Fi Direct group to further effectively and reasonably manage the wireless device of the Wi-Fi Direct group.

### BRIEF DESCRIPTION OF THE DRAWINGS

FIG. 1 is a schematic flowchart of a first embodiment illustrating a method for controlling disconnection of a wireless device of a Wi-Fi Direct group according to the disclosure;

FIG. 2 is a schematic flowchart of a second embodiment illustrating a method for controlling disconnection of a wireless device of a Wi-Fi Direct group according to the disclosure; and

FIG. 3 is a functional module diagram of a preferred embodiment illustrating a wireless device according to the disclosure.

### DETAILED DESCRIPTION

It will be appreciated that specific embodiments described herein are merely intended to explain the disclosure and are not intended to limit the disclosure.

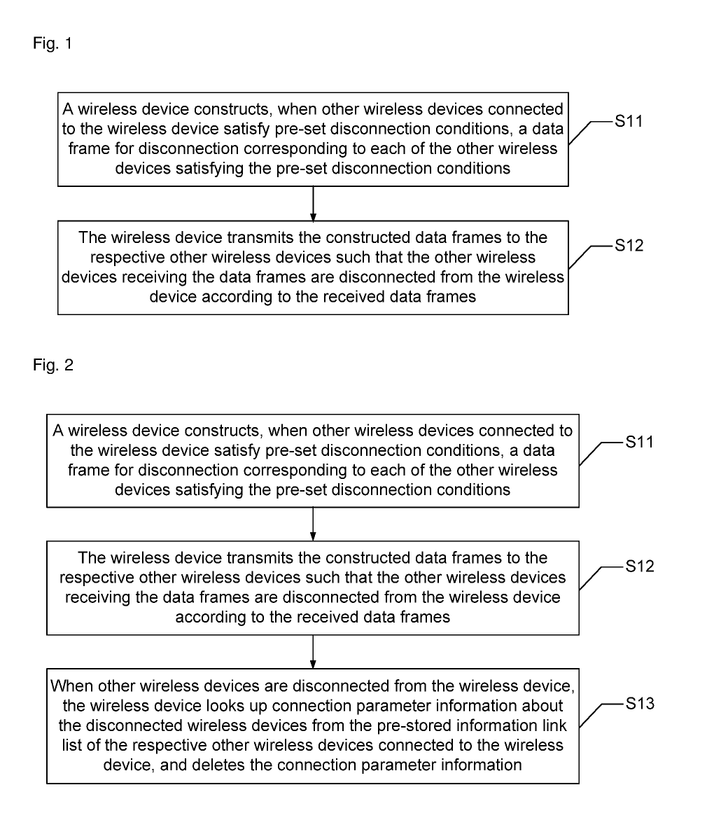

FIG. 1 shows a schematic flowchart of a first embodiment illustrating a method for controlling disconnection of a wireless device of a Wi-Fi Direct group according to the disclosure.

It should be emphasized that the schematic flowchart shown in FIG. 1 is only a preferred embodiment. Those skilled in the art shall know that any embodiments constructed based on the idea of the disclosure shall not depart from the scope of the technical solution as follows.

A wireless device constructs, when other wireless devices connected to the wireless device satisfy pre-set disconnection conditions, a data frame for disconnection corresponding to each of the other wireless devices satisfying the pre-set disconnection conditions; and the wireless device transmits the constructed data frames to the respective other wireless devices such that the other wireless devices receiving the data frames are disconnected from the wireless device according to the received data frames.

Controlling of disconnection of a wireless device of a Wi-Fi Direct group is implemented in this embodiment step by step by means of the steps as follows.

Step S11: A wireless device constructs, when other wireless devices connected to the wireless device satisfy pre-set disconnection conditions, a data frame for disconnection corresponding to each of the other wireless devices satisfying the pre-set disconnection conditions.

In this embodiment, Wi-Fi Direct is characterized by allowing Wi-Fi Direct devices in a wireless network to be interconnected without using a wireless router. The Wi-Fi Direct devices can be interconnected anytime and anywhere. Since the wireless router or a wireless AP is not necessary, different Wi-Fi direct devices may be interconnected at any places. A Wi-Fi Direct device discovery function and a Wi-Fi Direct service discovery function assist a user in determining available devices and services and then establishing a connection. When a Wi-Fi Direct device needs to be connected to other wireless devices by means of Wi-Fi Direct, the Wi-Fi Direct device finds the other wireless devices by means of device discovery and is wirelessly connected to the other wireless devices so as to constitute a Wi-Fi Direct group, and the other wireless devices may be Wi-Fi Direct devices or may also be traditional wireless devices which are not Wi-Fi Direct devices. In this embodiment, preferably, at least three wireless devices are included in the Wi-Fi Direct group, and one of the wireless devices is a Wi-Fi Direct device. In other embodiments of the disclosure, only two wireless devices may be included in the Wi-Fi Direct group, and one of the wireless devices is a Wi-Fi Direct device.

After the Wi-Fi Direct group is successfully set up, wireless devices of the Wi-Fi Direct group are Wi-Fi Direct devices. Any one of the Wi-Fi Direct devices of the Wi-Fi Direct group may serve as a GO, configured to manage the wireless devices of the Wi-Fi Direct group; and other wireless devices serve as GCs. In this embodiment, preferably, a second wireless device of the Wi-Fi Direct group is a GO, and other wireless devices are first wireless devices namely GCs. The second wireless device detects, in real time, whether first wireless devices connected to the wireless device of the Wi-Fi Direct group satisfy pre-set disconnection conditions (that is, a wireless device detects, in real time, whether other wireless devices connected to the wireless device of the Wi-Fi Direct group satisfy pre-set disconnection conditions, the wireless device is a second wireless device, the other wireless devices are the first wireless devices, and the first wireless devices may be a wireless device serving as a GC or may be a plurality of wireless devices serving as GCs), and when the first wireless devices satisfy the pre-set disconnection conditions, the second wireless device constructs a data frame for disconnection corresponding to each of the first wireless devices satisfying the pre-set disconnection conditions. The pre-set disconnection conditions may be any applicable disconnection conditions, such as condition that the downlink traffic of a first wireless device is greater than a pre-set traffic value, condition that a first wireless device does not transmit data traffic for a pre-set time period, or condition that a signal of the first wireless device is smaller than a pre-set signal value, set by users in advance. The pre-set traffic value may be any usage traffic value, such as 5 MB or 10 MB, set by users in advance. The pre-set time period may be any time interval, such as 5 min or 10 min, set by users in advance after a wireless network group is successfully created. The pre-set signal value may be any signal value, such one or two signal bars, set by users in advance.

Said data frame includes a Media Access Control (MAC) address of the second wireless device, an MAC address of the corresponding first wireless device satisfying the pre-set disconnection conditions, and reasons for and type of disconnection from the second wireless device. Said data frame is divided into a Destination Address (DA) field, a Differentiated Service (DS) field, a frame control bit and a frame body, wherein the MAC address of the corresponding first wireless device fills in the DA field, the MAC address of the second wireless device fills in the DS field, the frame control bit identifies a current data frame type as a disconnection frame using an unused 0110 reserved in a Wi-Fi Direct protocol or may identify the current data frame type as the disconnection frame using an unused identifier reserved in the Wi-Fi Direct protocol, the frame body adopts a Tag/Length/Value (TLV) coding mode, including reasons for disconnection and a type of disconnection, the reasons for disconnection may be any applicable disconnection reasons set by users in advance, for example, the downlink traffic of the first wireless device is greater than a pre-set value, the first wireless device does not transmit data traffic for a pre-set time period or a first wireless device signal is smaller than a pre-set signal value, and the type of disconnection includes immediate disconnection and delayed disconnection.

Step S12: The wireless device transmits the constructed data frames to the respective other wireless devices such that the other wireless devices receiving the data frames are disconnected from the wireless device according to the received data frames.

In this embodiment, after successfully constructing the data frame for disconnections, the second wireless device transmits the constructed data frames to the respective first wireless devices, and the second wireless device, preferably, transmits the constructed data frames to the respective first wireless devices such that the first wireless devices receiving the data frames are disconnected from the second wireless device according to the received data frames.

The process that the first wireless devices receiving the data frames are disconnected from the second wireless device according to the received data frames includes that: the first wireless devices analyze whether the data frames are data frames indicative of disconnection from the second wireless device, that is, the first wireless devices analyze whether the data frames indicating that there is a need to disconnect the first wireless devices from the second wireless device and to remove the first wireless devices from the Wi-Fi Direct group; when the data frames are the data frames indicative of disconnection from the second wireless device, the first wireless devices acquire reasons for and type of disconnection from the second wireless device from the data frames, wherein data frames corresponding to the acquired reasons about disconnection from the second wireless device are coding data frames, the first wireless devices generate corresponding character strings from the data frames corresponding to the acquired reasons about disconnection from the second wireless device in order to prompt the reasons for disconnection to a user, and the first wireless devices analyze whether the data frames are data frames indicative of immediate disconnection from the second wireless device; and when the data frames are not the data frames indicative of immediate disconnection from the second wireless device, the data frames are processed in accordance with a normal parsing flow for a frame. When the data frames are the data frames indicative of immediate disconnection from the second wireless device, the first wireless devices are disconnected from the second wireless device, and the reasons for disconnection are prompted. When the data frames are not the data frames indicative of immediate disconnection from the second wireless device, the first wireless devices start timing; and when a pre-set time period elapses, the first wireless devices are disconnected from the second wireless device, and the reasons for disconnection are prompted. The pre-set time period is any applicable time interval, such as 30 s or 1 min, set by users in advance, starting from a moment at which it is analyzed that the data frames are not the data frames indicative of immediate disconnection from the second wireless device. In other embodiments of the disclosure, in order to enable a user to know, in time, whether a used wireless device is normally connected to other wireless devices of the Wi-Fi Direct group or whether the used wireless device is disconnected from or about to be disconnected from the other wireless devices of the Wi-Fi Direct group, when the data frames are the data frames indicative of immediate disconnection from the second wireless device, a reminding message indicative of immediate disconnection from the second wireless device is transmitted to remind the user to immediately disconnect from the second wireless device; and when the data frames are not the data frames indicative of immediate disconnection from the second wireless device, a reminding message indicative of disconnection from the second wireless device after a pre-set time period is transmitted, and timing is started. The reminding message may be transmitted in a text mode, a picture mode, a sound mode or the like.

In this embodiment, a wireless device constructs, when other wireless devices connected to the wireless device satisfy pre-set disconnection conditions, a data frame for disconnection corresponding to each of the other wireless devices satisfying the pre-set disconnection conditions; and the wireless device transmits the constructed data frames to the respective other wireless devices such that the other wireless devices receiving the data frames are disconnected from the wireless device according to the received data frames, thereby achieving selective disconnection of a wireless device of a Wi-Fi Direct group to further effectively and reasonably manage the wireless device of the Wi-Fi Direct group.

FIG. 2 shows a schematic flowchart of a second embodiment illustrating a method for controlling disconnection of a wireless device of a Wi-Fi Direct group according to the disclosure.

On the basis of the first embodiment, the wireless device pre-stores an information link list of the respective other wireless devices connected to the wireless device, and the method further includes the step as follows which is performed after S12.

Step S13: When other wireless devices are disconnected from the wireless device, the wireless device looks up connection parameter information about the disconnected wireless devices from the pre-stored information link list of the respective other wireless devices connected to the wireless device, and deletes the connection parameter information.

In this embodiment, the wireless device pre-stores the information link list of the respective other wireless devices connected to the wireless device, that is, the second wireless device pre-stores an information link list of the respective first wireless devices connected to the wireless device. In a Wi-Fi Direct group, a wireless device is selected as a GO, which pre-stores information about other wireless devices of the Wi-Fi Direct group and constructs an information link list based on the information about the other wireless devices. When first wireless devices of the Wi-Fi Direct group satisfy pre-set disconnection conditions, the second wireless device constructs a data frame for disconnection corresponding to each of the first wireless devices satisfying the pre-set disconnection conditions, and the second wireless device transmits the constructed data frames to the respective first wireless devices; and when first wireless devices are disconnected from the second wireless device, the second wireless device looks up connection parameter information about the first wireless devices satisfying the pre-set disconnection conditions from the pre-stored information link list of the respective first wireless devices connected to the second wireless device, and deletes the connection parameter information.

In this embodiment, when other wireless devices are disconnected from the wireless device, the wireless device looks up connection parameter information about the disconnected wireless devices from the pre-stored information link list of the respective other wireless devices connected to the wireless device, and deletes the connection parameter information. It is ensured that the other wireless devices satisfying pre-set disconnection conditions are disconnected from the wireless device, and meanwhile, a storage space of the wireless device is saved.

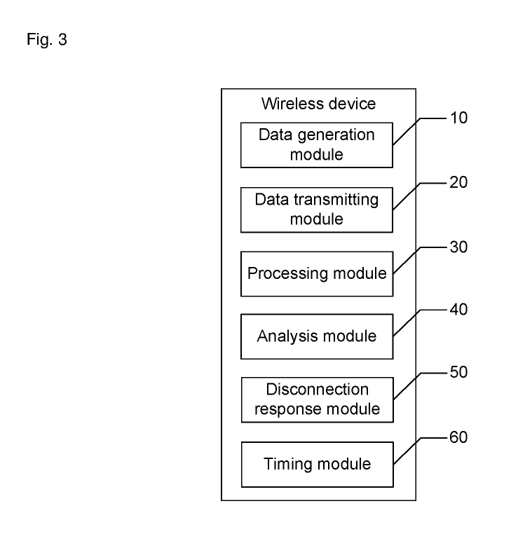

FIG. 3 shows a functional module diagram of a preferred embodiment illustrating a wireless device according to the disclosure. The apparatus includes: a data generation module 10, a data transmitting module 20, a processing module 30, an analysis module 40, a disconnection response module 50 and a timing module 60.

The data generation module 10 is configured to construct, when other wireless devices connected to the wireless device satisfy pre-set disconnection conditions, a data frame for disconnection corresponding to each of the other wireless devices satisfying the pre-set disconnection conditions.

In this embodiment, Wi-Fi Direct is characterized by allowing Wi-Fi Direct devices in a wireless network to be interconnected without using a wireless router. The Wi-Fi Direct devices can be interconnected anytime and anywhere. Since the wireless router or a wireless AP is not necessary, different Wi-Fi direct devices may be interconnected at any places. A Wi-Fi Direct device discovery function and a Wi-Fi Direct service discovery function assist a user in determining available devices and services and then establishing a connection. When a Wi-Fi Direct device needs to be connected to other wireless devices by means of Wi-Fi Direct, the Wi-Fi Direct device finds the other wireless devices by means of device discovery and is wirelessly connected to the other wireless devices so as to constitute a Wi-Fi Direct group, and the other wireless devices may be Wi-Fi Direct devices or may also be traditional wireless devices which are not Wi-Fi Direct devices. In this embodiment, preferably, at least three wireless devices are included in the Wi-Fi Direct group, and one of the wireless devices is a Wi-Fi Direct device. In other embodiments of the disclosure, only two wireless devices may be included in the Wi-Fi Direct group, and one of the wireless devices is a Wi-Fi Direct device.

After the Wi-Fi Direct group is successfully set up, wireless devices of the Wi-Fi Direct group are Wi-Fi Direct devices. Any one of the Wi-Fi Direct devices of the Wi-Fi Direct group may serve as a GO, configured to manage the wireless devices of the Wi-Fi Direct group; and other wireless devices serve as GCs. The data transmitting module 20 detects, in real time, whether first wireless devices of the Wi-Fi Direct group satisfy pre-set disconnection conditions (that is, a wireless device detects, in real time, whether other wireless devices connected to the wireless device of the Wi-Fi Direct group satisfy pre-set disconnection conditions, the wireless device is a second wireless device, the other wireless devices are first wireless devices, and the first wireless devices may be a wireless device serving as a GC or may be a plurality of wireless devices serving as GCs), and when the first wireless devices satisfy the pre-set disconnection conditions, the data generation module 10 constructs a data frame for disconnection corresponding to each of the first wireless devices satisfying the pre-set disconnection conditions. The pre-set disconnection conditions may be any applicable disconnection conditions, such as condition that the downlink traffic of a first wireless device is greater than a pre-set traffic value, condition that a first wireless device does not transmit data traffic for a pre-set time period or condition that a signal of the first wireless device is smaller than a pre-set signal value, set by users in advance. The pre-set traffic value may be any usage traffic value, such as 5 MB, 10 MB or the like, set by users in advance. The pre-set time period may be any time interval, such as 5 min, 10 min or the like, after a wireless network group is successfully created set by users in advance. The pre-set signal value may be any signal value, such as one or two signal bars, set by users in advance.

Each data frame includes an MAC address of the second wireless device, an MAC address of the first wireless device satisfying the pre-set disconnection conditions, and reasons for and type of disconnection from the second wireless device. Each data frame is divided into a DA field, a DS field, a frame control bit and a frame body, wherein the MAC address of the first wireless device fills in the DA field, the MAC address of the second wireless device fills in the DS field, the frame control bit identifies a current data frame type as a disconnection frame using an unused 0110 reserved in a Wi-Fi Direct protocol or may identify the current data frame type as the disconnection frame using an unused identifier reserved in the Wi-Fi Direct protocol, the frame body adopts a TLV coding mode, including reasons for disconnection and type of disconnection, the reasons for disconnection may be any applicable disconnection reason set by users in advance, for example, the downlink traffic of the first wireless device is greater than a pre-set value, the first wireless device does not transmit data traffic for a pre-set time period or a signal of the first wireless device is smaller than a pre-set signal value, and the type of disconnection includes immediate disconnection and delayed disconnection.

The data transmitting module 20 is configured to transmit the constructed data frames to the respective other wireless devices such that the other wireless devices receiving the data frames are disconnected from the wireless device according to the received data frames.

In this embodiment, after the data generation module 10 successfully constructs the data frame for disconnections, the data transmitting module 20 transmits the constructed data frames to the respective first wireless devices, and the data transmitting module 20, preferably, transmits the constructed data frames to the respective first wireless devices via link layers such that the first wireless devices receiving the data frames are disconnected from the second wireless device according to the received data frames. When the wireless device performs operations by using the data generation module 10 and the data transmitting module included therein, the wireless device serves as a GO, that is, the second wireless device serves as a GO device.

The process that the processing module 30, the analysis module 40, the disconnection response module 50 and the timing module 60 are disconnected from the second wireless device according to the received data frames includes that: when the wireless device is connected to the other wireless devices and receives the data frame for disconnections transmitted from the other wireless devices, the analysis module 40 analyzes whether the data frames are data frames indicative of disconnection from the second wireless device, that is, the analysis module 40 analyzes whether the data frames indicating that there is need to disconnect from the second wireless device and to remove from the Wi-Fi Direct group; when the data frames are the data frames indicative of disconnection from the second wireless device, the processing module 30 acquires reasons for and type of disconnection from the second wireless device from the data frames, wherein data frames corresponding to the acquired reasons about disconnection from the second wireless device are coding data frames, the processing module 30 generates corresponding character strings from the data frames corresponding to the acquired reasons about disconnection from the second wireless device in order to prompt the reasons for disconnection to a user, and the analysis module 40 analyzes whether the data frames are data frames indicative of immediate disconnection from the second wireless device; and when the data frames are not the data frames indicative of immediate disconnection from the second wireless device, the processing module 30 processes the data frames in accordance with a normal parsing flow for a frame. When the data frames are the data frames indicative of immediate disconnection from the second wireless device, the disconnection response module 50 is disconnected from the second wireless device, and reasons for disconnection are prompted. When the data frames are not the data frames indicative of immediate disconnection from the second wireless device, the timing module 60 starts timing; and when a pre-set time period elapses, the disconnection response module 50 is disconnected from the second wireless device, and reasons for disconnection are prompted. The pre-set time period is any applicable time interval, such as 30 s or 1 min, set by users in advance, starting from a moment at which the analysis module 40 analyzes that the data frames are not the data frames indicative of immediate disconnection from the second wireless device. In other embodiments of the disclosure, in order to enable a user to know, in time, whether a used wireless device is normally connected to other wireless devices of the Wi-Fi Direct group or whether the used wireless device is disconnected from or about to be disconnected from the other wireless devices of the Wi-Fi Direct group, when the data frames are the data frames indicative of immediate disconnection from the second wireless device, the processing module 30 transmits a reminding message indicative of immediate disconnection from the second wireless device to remind the user to immediately disconnect from the second wireless device; and when the data frames are not the data frames indicative of immediate disconnection from the second wireless device, the processing module 30 transmits a reminding message indicative of disconnection from the second wireless device after a pre-set time period, and the timing module 60 starts timing. The reminding message may be transmitted in a text mode, a picture mode, a sound mode or the like. When the wireless device performs operations by using the processing module 30, the analysis module 40, the disconnection response module 50 and the timing module 60 included therein, the wireless device serves as a GC.

In this embodiment, the data generation module 10 constructs, when other wireless devices connected to the wireless device satisfy pre-set disconnection conditions, a data frame for disconnection corresponding to each of the other wireless devices satisfying the pre-set disconnection conditions; and the data transmitting module 20 transmits the constructed data frames to the respective other wireless devices such that the other wireless devices receiving the data frames are disconnected from the wireless device according to the received data frames, thereby achieving selective disconnection of a wireless device of a Wi-Fi Direct group to further effectively and reasonably manage the wireless device of the Wi-Fi Direct group.

Preferably, the wireless device pre-stores an information link list of the respective other wireless devices connected to the wireless device. The processing module 30 is configured to look up, by the wireless device, when other wireless devices are disconnected from the wireless device, connection parameter information about the disconnected wireless devices from the pre-stored information link list of the respective other wireless devices connected to the wireless device, and delete the connection parameter information.

In this embodiment, the wireless device pre-stores the information link list of the respective other wireless devices connected to the wireless device, that is, the second wireless device pre-stores an information link list of the respective first wireless devices connected to the wireless device. In a Wi-Fi Direct group, a wireless device is selected as a GO, which pre-stores information about other wireless devices of the Wi-Fi Direct group and constructs an information link list based on the information about the other wireless devices. In this embodiment, the wireless device is a GO (a second wireless device), and other wireless devices (first wireless devices) are GCs. When first wireless devices of the Wi-Fi Direct group satisfy pre-set disconnection conditions, the data generation module 10 constructs a data frame for disconnection corresponding to each of the first wireless devices satisfying the pre-set disconnection conditions, and the data transmitting module 20 transmits the constructed data frames to the respective first wireless devices; and when first wireless devices are disconnected from the wireless device, the processing module 30 looks up connection parameter information about the first wireless devices satisfying the pre-set disconnection conditions from the pre-stored information link list of the respective first wireless devices connected to the wireless device, and deletes the connection parameter information.

In this embodiment, when other wireless devices are disconnected from the wireless device, the processing module 30 looks up connection parameter information about the disconnected wireless devices from the pre-stored information link list of the respective other wireless devices connected to the wireless device, and deletes the connection parameter information. It is ensured that the other wireless devices satisfying pre-set disconnection conditions are disconnected from the wireless device, and meanwhile, a storage space of the wireless device is saved.

According to an embodiment of the disclosure, a computer storage medium is further proposed. Computer executable instructions are stored in the computer storage medium and configured to execute the above method.

The sequence numbers of the embodiments of the disclosure are merely used for descriptions and do not represent the strengths and weaknesses of the embodiments. By describing the above implementation mode, those skilled in the art may clearly know that the embodiment methods may be implemented by means of software and a necessary general purpose hardware platform, or may, certainly, be implemented by hardware. However, under many circumstances, the former is a preferred implementation mode. Based on this understanding, the technical solutions of the disclosure may be substantially embodied in a form of a software product or parts contributing to the traditional art may be embodied in a form of a software product, and a computer software product is stored in a storage medium (for example, a Read-Only Memory/Random Access Memory (ROM/RAM), a magnetic disk or an optical disc), which includes a plurality of instructions enabling a terminal device (a mobile phone, a computer, a server, a network device or the like) to perform the method according to the respective embodiments of the disclosure.

The respective modules may be implemented by a Central Processing Unit (CPU), a Digital Signal Processor (DSP) or a Field-Programmable Gate Array (FPGA) in an electronic device.

Those skilled in the art shall understand that the embodiments of the disclosure may be provided as a method, a system or a computer program product. Thus, the disclosure may be embodied in forms of hardware embodiments, software embodiments or embodiments combining software and hardware. Moreover, the disclosure may be embodied in a form of the computer program product implemented on one or more computer available storage media (including, but not limited to, a magnatic disk memory, an optical memory and the like) containing computer available program codes.

The disclosure is described with reference to flow charts and/or block diagrams of the method, the device (system) and the computer program product according to the embodiments of the disclosure. It will be appreciated that each flow and/or block in the flow charts and/or the block diagrams and a combination of the flows and/or the blocks in the flow charts and/or the block diagrams may be implemented by computer program instructions. These computer program instructions may be provided for a general computer, a dedicated computer, an embedded processor or processors of other programmable data processing devices to generate a machine, such that an apparatus for implementing functions specified in one or more flows of the flow charts and/or one or more blocks of the block diagrams is generated via instructions executed by the computers or the processors of the other programmable data processing devices.

These computer program instructions may also be stored in a computer readable memory capable of guiding the computers or the other programmable data processing devices to operate in a specific mode, such that a manufactured product including an instruction apparatus is generated via the instructions stored in the computer readable memory, and the instruction apparatus implements the functions specified in one or more flows of the flow charts and/or one or more blocks of the block diagrams.

These computer program instructions may also be loaded to the computers or the other programmable data processing devices, such that processing implemented by the computers is generated by executing a series of operation steps on the computers or the other programmable devices, and therefore the instructions executed on the computers or the other programmable devices provide steps for implementing the functions specified in one or more flows of the flow charts and/or one or more blocks of the block diagrams.

The above is only the preferred embodiments of the disclosure and does not limit the patent scope of the disclosure accordingly. Equivalent structure or equivalent flow transformations made by utilizing the description and drawings of the disclosure or direct or indirect applications to other relevant technical fields may fall within the patent protection scope of the disclosure in the same way.

1. A method for controlling disconnection of a wireless device of a Wi-Fi Direct group, comprising:
constructing, by a wireless device, when other wireless devices connected to the wireless device satisfy pre-set disconnection conditions, a data frame for disconnection corresponding to each of the other wireless devices satisfying the pre-set disconnection conditions; and
transmitting, by the wireless device, the constructed data frames to the respective other wireless devices thereby disconnecting the other wireless devices receiving the data frames from the wireless device according to the received data frames.

2. The method for controlling disconnection of a wireless device of a Wi-Fi Direct group according to claim 1, wherein the wireless device pre-stores an information link list of the respective other wireless devices connected to the wireless device, and the method further comprises: after the step of transmitting, by the wireless device, the constructed data frames to the respective other wireless devices thereby disconnecting the other wireless devices receiving the data frames from the wireless device according to the received data frames,
looking up, by the wireless device, when other wireless devices are disconnected from the wireless device, connection parameter information about the disconnected other wireless devices from the pre-stored information link list of the respective other wireless devices connected to the wireless device, and deleting the connection parameter information.

3. The method for controlling disconnection of a wireless device of a Wi-Fi Direct group according to claim 1, wherein the step of disconnecting the other wireless devices receiving the data frames from the wireless device according to the received data frames comprises:
analyzing whether the data frames are data frames indicative of disconnection from the wireless device;
acquiring, when the data frames are the data frames indicative of disconnection from the wireless device, reasons for and type of disconnection from the wireless device from the data frames, and analyzing whether the data frames are data frames indicative of immediate disconnection from the wireless device; and
disconnecting, when the data frames are the data frames indicative of immediate disconnection from the wireless device, the other wireless devices from the wireless device and prompting the reasons for disconnection.

4. The method for controlling disconnection of a wireless device of a Wi-Fi Direct group according to claim 3, wherein the method comprises: after the step of analyzing whether the data frames are the data frames indicative of immediate disconnection from the wireless device performed by the other wireless devices receiving the data frames,
starting timing when the data frames are not the data frames indicative of immediate disconnection from the wireless device; and
disconnecting, when a pre-set time period elapses, the other wireless devices from the wireless device and prompting the reasons for disconnection.

5. The method for controlling disconnection of a wireless device of a Wi-Fi Direct group according to claim 4, wherein the step of starting timing when the data frames are not the data frames indicative of immediate disconnection from the wireless device performed by the other wireless devices receiving the data frames comprises:
transmitting, when the data frames are not the data frames indicative of immediate disconnection from the wireless device, a reminding message indicative of disconnection from the wireless device after the pre-set time period and starting timing.

6. A wireless device, comprising:
a data generation module, configured to construct, when other wireless devices connected to the wireless device satisfy pre-set disconnection conditions, a data frame for disconnection corresponding to each of the other wireless devices satisfying the pre-set disconnection conditions; and
a data transmitting module, configured to transmit the constructed data frames to the respective other wireless devices such that the other wireless devices receiving the data frames are disconnected from the wireless device according to the received data frames.

7. The wireless device according to claim 6, wherein the wireless device pre-stores an information link list of the respective other wireless devices connected to the wireless device, and the wireless device further comprises:
a processing module configured to look up, when other wireless devices are disconnected from the wireless device, connection parameter information about the disconnected other wireless devices from the pre-stored information link list of the respective other wireless devices connected to the wireless device, and delete the connection parameter information.

8. The wireless device according to claim 6, further comprising an analysis module and a disconnection response module, wherein
the analysis module is configured to analyze, when the wireless device is connected to the other wireless devices and receives the data frame for disconnections transmitted from the other wireless devices, whether the data frames are data frames indicative of disconnection from the wireless device;
the processing module is further configured to acquire, when the data frames are the data frames indicative of disconnection from the wireless device, reasons for and type of disconnection from the wireless device from the data frames, and the analysis module analyzes whether the data frames are data frames indicative of immediate disconnection from the wireless device; and
the disconnection response module is configured to disconnect, when the data frames are the data frames indicative of immediate disconnection from the wireless device, from the wireless device and prompt the reasons for disconnection.

9. The wireless device according to claim 8, further comprising a timing module, wherein
the timing module is configured to start timing when the data frames are not the data frames indicative of immediate disconnection from the wireless device; and
the disconnection response module is configured to disconnect, when a pre-set time period elapses, from the wireless device and prompt the reasons for disconnection.

10. The wireless device according to claim 9, wherein
the processing module is further configured to transmit, when the data frames are not the data frames indicative of immediate disconnection from the wireless device, a reminding message indicative of disconnection from the wireless device after the pre-set time period and the timing module starts timing.

11. A computer storage medium storing therein computer executable instructions configured to execute a method for controlling disconnection of a wireless device of a Wi-Fi Direct group, the method comprising:
constructing, by a wireless device, when other wireless devices connected to the wireless device satisfy pre-set disconnection conditions, a data frame for disconnection corresponding to each of the other wireless devices satisfying the pre-set disconnection conditions; and
transmitting, by the wireless device, the constructed data frames to the respective other wireless devices thereby disconnecting the other wireless devices receiving the data frames from the wireless device according to the received data frames.
